(19) United States
(12) Patent Application Publication
(10) Pub. No.: US 2026/0252740 A1
(43) Pub. Date: Aug. 27, 2026

(54) MANAGING STARTUP OF A DATA PROCESSING SYSTEM USING AN SPDM HARDWARE COMPONENT POLICY

(71) Applicant: Dell Products L.P., Round Rock, TX (US)

(72) Inventors: NICHOLAS D. GROBELNY, Evergreen, CO (US); AMY CHRISTINE NELSON, Round Rock, TX (US); DAVID ALBERT CONSOLVER, Hurst, TX (US); RAMAN SHARMA, Leander, TX (US); RICHARD M. TONRY, Georgetown, TX (US)

(21) Appl. No.: 19/062,644

(22) Filed: Feb. 25, 2025

(51) Int. Cl. G06F 21/73; G06F 21/60; G06F 21/64

(52) U.S. Cl. CPC G06F 21/73; G06F 21/604; G06F 21/64

(57) ABSTRACT

Methods and systems for managing operation of a data processing system are disclosed. To manage operation of the data processing system, during a startup of the data processing system, an entity may perform, using identification data obtained from a hardware component of the data processing system using a security protocol and data model (SDPM) security standard, an analysis process to identify a level of trust for the hardware component. Based on the level of trust and an SPDM hardware component policy, at least one action to manage operation of the data processing system may be identified. The at least one action may be performed to reduce a likelihood of the data processing system being compromised.

### FIELD

Embodiments disclosed herein relate generally to managing operation of a data processing system. More particularly, embodiments disclosed herein relate to systems and methods to manage startup of a data processing system using an SPDM hardware component policy.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 3 shows a flow diagram illustrating a method for managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may include hardware and/or software components that, in some combination, may be used to provide computer-implemented services. To provide the computer-implemented services, the data processing system may undergo a startup during which functionality of a portion of its hardware and/or software components may be enabled.

During the startup, a startup manager (e.g., a basic input/output system (BIOS)) of the data processing system (and/or any other entity) may perform various tasks to establish trust by the data processing system in the hardware and/or software components. Doing so may reduce a risk of compromise of the data processing system, errors occurring during startup, etc.

However, the startup manager may have a limited capacity to perform the startup tasks (e.g., due to its host hardware and/or program code). For example, operation of the startup manager may be limited by a single processor that executes instructions one after the other in a specific order (e.g., as in sequential processing). Since each of the startup tasks may also have some degree of time dependence, these limitations may cause bottlenecks (e.g., delays in completion of the startup). Such delays may consume an undesirable amount of computational and/or time resources, which may negatively affect the quality and/or availability of the computer-implemented services.

To improve startup speed, thereby reducing a resource consumption during the startup, a store of trusted identification data may be used by an entity (e.g., such as the startup manager) during the startup to establish trust in a hardware component. To do so, the entity may obtain identification data from the hardware component using a security protocol and data model (SPDM) security standard, which may include a certificate for the hardware component and/or a digest based on the certificate for the hardware component. The identification data may be usable to identify an acceptable manner of managing the hardware component by the entity.

The entity may perform an analysis process using the identification data and the store of trusted identification data to identify a level of trust for the hardware component. The level of trust may be: (i) trusted (e.g., if the identification data matches known good identification data in the store of trusted identification data), (ii) untrusted (e.g., if the identification data matches known bad identification data in the store of trusted identification data), and/or (iii) indeterminate (e.g., if the identification data does not match known good and/or known bad identification data).

Based on the level of trust and an SPDM hardware component policy, at least one action may be identified to manage operation of the data processing system. The SPDM hardware component policy may be obtained from a management entity of the data processing system, and may be keyed to levels of trust and/or types of SPDM devices.

Thus, embodiments disclosed herein may address, among other technical problems, the technical challenge of performing a startup of a data processing system in a manner that conserves resources while maintaining an acceptable level of security of the data processing system. By using a store of trusted identification data and an SPDM hardware component policy, an amount of time to establish a level of trust in hardware components and identify actions to manage the hardware components may be reduced. Consequently, startup time may be reduced, and computer-implemented services may be provided in a timely manner.

In an embodiment, a method for managing operation of a data processing system is disclosed. The method may include: during a startup of a data processing system: performing, by an entity of the data processing system and using identification data obtained from a hardware component of the data processing system using a security protocol and data model (SPDM) security standard, an analysis process to identify a level of trust for the hardware component, the identification data being usable to identify an acceptable manner of managing operation of the hardware component by the entity; identifying, based on the level of trust and an SPDM hardware component policy, at least one action to manage operation of the data processing system; and performing the at least one action to reduce a likelihood of the data processing system being compromised.

Performing the analysis process may include: obtaining, by the entity and via an SPDM message exchange with the hardware component, the identification data; and identifying, by the entity and using at least the identification data and a store of trusted identification data, the level of trust for the hardware component.

The identification data may include a certificate for the hardware component, the certificate being cryptographically verifiable, and/or a digest of the certificate.

The digest may be obtained by applying a predetermined function to the certificate.

The level of trust may include at least one level of trust selected from a list consisting of: trusted, untrusted, and indeterminate.

The SPDM hardware component policy may include actions keyed to levels of trust for hardware components, and the SPDM hardware component policy may be obtained from a management entity of the data processing system.

The SPDM hardware component policy may include the actions keyed to types of SPDM hardware components.

The at least one action to manage operation of the data processing system may include at least one action selected from a list of actions consisting of: preventing the hardware component from performing at least a portion of its functionality; allowing the hardware component to perform at least a portion of its functionality; performing, by the entity, a measurement process using the SPDM security standard for the hardware component; logging information regarding the hardware component; and quarantining the hardware component.

The SPDM security standard may be a data model for hardware components of data processing systems, the SPDM security standard specifying, at least, methods of security communication between the hardware components, minimum standards of data to be made available to other hardware components, and security information to be made available to the other hardware components.

The entity of the data processing system may be a basic input-output system (BIOS).

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

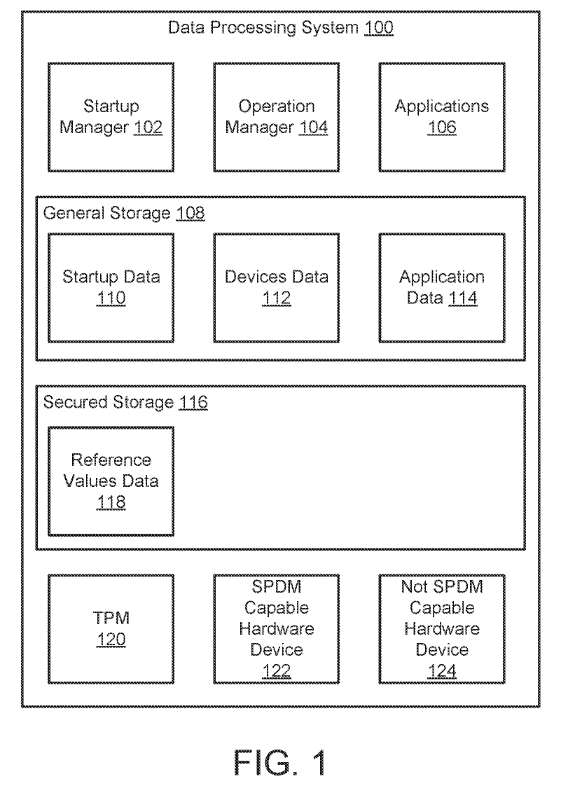

Turning to FIG. 1, a block diagram illustrating a system in accordance with an embodiment is shown. The system shown in FIG. 1 may provide computer-implemented services. The computer-implemented services may include, for example, database services, data processing services, communication services, and/or any other services that may be provided using one or more computing devices. Other types of computer-implemented services may be provided by the system without departing from embodiments disclosed herein.

To provide the computer-implemented services, the system (e.g., a data processing system) may undergo a startup during which functionality of a portion of its hardware and/or software components may be enabled. For example, the computer-implemented services may require access to processors, memory modules, storage devices, communication devices, and/or other devices operably connected to the data processing system. The hardware components may support execution of any number and/or type of software components (e.g., applications), and, in some combination, the hardware and software components may provide for various types of computer-implemented services.

To perform the startup, an entity of the data processing system (e.g., a startup manager such as a basic input/output system (BIOS)) may access, verify, and use data stored by the data processing system and/or retrieved from the hardware components (e.g., startup data). The startup data may include instructions corresponding to software usable to facilitate various tasks of the startup (e.g., tasks for performing device verification and initialization, and/or other tasks related to enabling and/or securing hardware functionality), data structures usable to verify the integrity and/or authenticity of the software hosted by the hardware components (e.g., firmware), and/or data structures usable to identify an acceptable manner of managing operation of the hardware components (e.g., identification data such as certificates).

For example, during a secure boot (e.g., a type of startup) of the data processing system, the tasks may include security checks where integrity of portions of the startup data are validated (e.g., secure boot verification). The secure boot verification may be performed (e.g., using reference values data stored by the data processing system, using a security manager of the data processing system such as a trusted platform module) in order to establish trust in each portion of the startup data before use (e.g., execution), so that exposure to malicious or erroneous software is unlikely. Doing so may reduce a risk of compromise of the data processing system, errors occurring during startup, etc.

The tasks associated with the startup may be performed by the startup manager in sequence throughout the startup process. By performing the tasks associated with the startup in sequence, the risk of compromise of the data processing system may be further reduced.

To perform the tasks associated with the startup, the startup manager may communicate with the hardware components (e.g., devices) using a predefined industry standard, such as the security protocol and data model (e.g., SPDM) security standard. Communicating with the devices using the SPDM security standard may allow the startup manager to retrieve data structures from the devices usable to verify the integrity and/or authenticity of the software hosted by the devices and/or analyze the identification data in a manner that establishes an acceptable level of trust that the devices will not compromise the data processing system once booted.

However, the startup manager may have a limited capacity to perform the startup tasks (e.g., due to its host hardware and/or program code). For example, operation of the startup manager may be limited by a single processor that executes instructions one after the other in a specific order (e.g., as in sequential processing). Since each of the startup tasks may also have some degree of time dependence, these limitations may cause bottlenecks (e.g., delays in completion of the startup process). Such delays may consume an undesirable amount of computational and/or time resources, which may negatively affect the quality and/or availability of the computer-implemented services.

In general, embodiments disclosed herein may provide methods, systems, and/or devices for managing startup of a data processing system in a manner that improves startup speed. To do so, an entity of the data processing system (e.g., a startup manager such as the BIOS and/or any other entity) may obtain identification data from a hardware component (e.g., device) of the data processing system using an SPDM security standard. The identification data may be usable to identify an acceptable manner of managing operation of the hardware component, and may include a certificate which is cryptographically verifiable, and/or a digest (e.g., hash) of the certificate. The entity may analyze the identification data using a store of trusted identification data to identify a level of trust for the hardware component. The entity may determine that the level of trust is: (i) trusted, (ii) untrusted, and/or (iii) indeterminate.

Based on the level of trust and an SPDM hardware component policy, the entity may identify at least one action to manage operation of the data processing system. The SPDM hardware component policy may include actions keyed to levels of trust for hardware components and/or types of hardware components. The SPDM hardware component policy may be obtained by the entity from a management entity of the data processing system (e.g., a manufacturer of the data processing system, a user of the data processing system) prior to the startup. The SPDM hardware component policy may be stored in the data processing system and accessed by the entity during the startup. The identified at least one action may then be performed to reduce a likelihood of the data processing system being compromised.

By doing so, embodiments disclosed herein may conserve computational and time resources during startup of a data processing system. During the startup, levels of trust for hardware components may be established using identification data obtained from the hardware components using an SPDM security standard. Based on the levels of trust and an SPDM hardware component policy, actions to manage the hardware components may be identified in a manner that reduces startup time while maintaining an acceptable level of security during the startup. Consequently, the computer-implemented services may be provided in a timely manner while reducing computational resources consumed.

To provide the above noted functionality, the system of FIG. 1 may include data processing system 100, startup manager 102, operation manager 104, applications 106, general storage 108, secured storage 116, trusted platform module (TPM) 120, security protocol and data model (SPDM) capable hardware device 122, and not SPDM capable hardware device 124. Each of these components is discussed below.

Data processing system 100 may include any number of hardware components (e.g., processors, memory modules, storage devices, communications chips, other devices). The hardware components may support execution of any number and/or type of software components (e.g., startup manager 102, operation manager 104, applications 106, etc.).

Data processing system 100 may provide any number and type of computer-implemented services. To provide the computer-implemented services, data processing system 100 may include startup manager 102. Startup manager 102 may include a startup management entity (e.g., a basic input/output system (BIOS)) hosted by a hardware processor of data processing system 100 and may facilitate management of startup of data processing system 100 from power on to booting to operation manager 104. The startup of data processing system 100 may include performing a secure boot procedure. During the secure boot procedure, startup manager 102 may perform tasks related to device verification and initialization, and/or other tasks related to enabling and/or securing hardware functionality.

To perform its functionality, startup manager 102 may: (i) perform device enumeration tasks to obtain a list of devices (e.g., hardware components) operably connected to data processing system 100 which are compliant with a security protocol and data model (SPDM) security standard (e.g., including obtaining identifiers for the devices such as globally unique identifiers (GUIDs)), (ii) collect, using the SPDM security standard, startup data (e.g., startup data 110) from the devices in the list of devices, the startup data including identification data (e.g., device certificates, digests of device certificates), (iii) obtain, using any type and/or quantity of predetermined functions (e.g., hash functions, other algorithms) digests for the device certificates (e.g., if the digests are not provided by the devices), (iv) identify, using at least a store of trusted identification data (e.g., stored as part of reference values data 118) and the identification data obtained from the devices, a level of trust for each device (e.g., trusted, untrusted, and/or indeterminate), (v) identify, based on the level of trust for each device and an SPDM hardware component policy, at least one action to manage operation of the data processing system, (vi) update the store of trusted identification data using information obtained while performing any processes during the startup, and/or (vii) perform other tasks.

The devices operably connected to data processing system 100 may be compliant with the SPDM security protocol (e.g., SPDM capable hardware device 122) or may not be compliant with the SPDM security protocol (e.g., not SPDM capable hardware device 124). SPDM capable hardware device 122 may include a device with SPDM capabilities. For example, SPDM capable hardware device 122 may be designed to comply with the SPDM security standard managed by the Distributed Management Task Force (DMTF). Complying with the SPDM security standard may allow the device to have its identity authenticated and its integrity verified in a manner that allows startup manager 102 to have an acceptable level of trust that the device is not compromised and/or malicious. Not SPDM capable hardware device 124 may be unable to have its identity authenticated and/or its integrity verified in the manner that allows startup manager 102 to have the acceptable level of trust. Thus, not SPDM capable hardware device 124 may be prevented from booting and/or may have a portion of its functionality restricted during operation of data processing system 100 (or at least until subsequent verification procedures are performed).

While described with respect to determining whether a device is compliant with the SPDM security protocol managed by the DMTF, it will be appreciated that device compliance with any other security standard may be determined in a similar manner without departing from embodiments disclosed herein.

Devices data 112 may include an existing list (and/or may be implemented using, for example, tables, unstructured data, trees, databases, etc.) for which startup manager 102 and/or any other entity has previously obtained information regarding SPDM capabilities. For example, devices data 112 may include an identifier for a device, and an indication corresponding to the identifier regarding whether the device is compliant with the SPDM security standard.

Devices data 112 may be stored in general storage 108 and may be used by startup manager 102 to determine whether any of the devices are new devices. For example, startup manager 102 may obtain an identifier for a graphics processing unit (GPU) during device enumeration. Startup manager 102 may perform a lookup process in a table of devices and corresponding SPDM capabilities included in devices data 112 using the identifier as a key for the lookup process. If startup manager 102 determines that the GPU is a new device (e.g., no entries in the table of devices correspond to the identifier), startup manager 102 may proceed to obtain the SPDM capabilities of the GPU.

The SPDM capabilities for a new device may be obtained by checking the firmware and/or system documentation of the new device to determine whether the new device supports the SPDM security standard. A dedicated tool and/or command may be used to query the new device for its specific SPDM capabilities, including supported cryptographic algorithms and/or certificate formats (e.g., via an SPDM message exchange with the new device to retrieve its identity certificate and/or associated details about its security features). Any information obtained from the new device while obtaining the SPDM capabilities of the new device may be added to devices data 112 and used during subsequent startups of data processing system 100.

For the SPDM security standard compliant devices (e.g., SPDM capable hardware device 122), startup manager 102 may obtain startup data 110 from the devices using the SPDM security standard. Startup data 110 may include data structures obtained from the devices that are usable to: (i) identify an acceptable manner of managing operation of the hardware components by startup manager 102 (e.g., using identification data such as certificates, digests of the certificates), (ii) identify actions to manage operation of the data processing system (e.g., based on the SPDM hardware component policy), and/or (iii) perform other tasks.

Startup data 110 may also include measurements obtained from SPDM security standard compliant devices. The measurements may be usable to verify the integrity and/or authenticity of the software hosted by the devices. The measurements may be obtained for any devices for which the SPDM hardware component policy indicates a measurement process is to be performed. The measurements may include cryptographic hashes, digital fingerprints, and/or other data structures that indicate the current state of a device's firmware, configuration, and/or other characteristics of the components. Startup manager 102 may perform the measurement process and may provide the measurements to trusted platform module (TPM) 120 to perform verification processes to verify the integrity and/or authenticity of the devices (e.g., using reference values data 118). Based on an outcome of the verification processes (e.g., a report generated by TPM 120), startup manager 102 may boot to operation manager 104, restrict capabilities of operation manager 104, and/or prevent booting to operation manager 104.

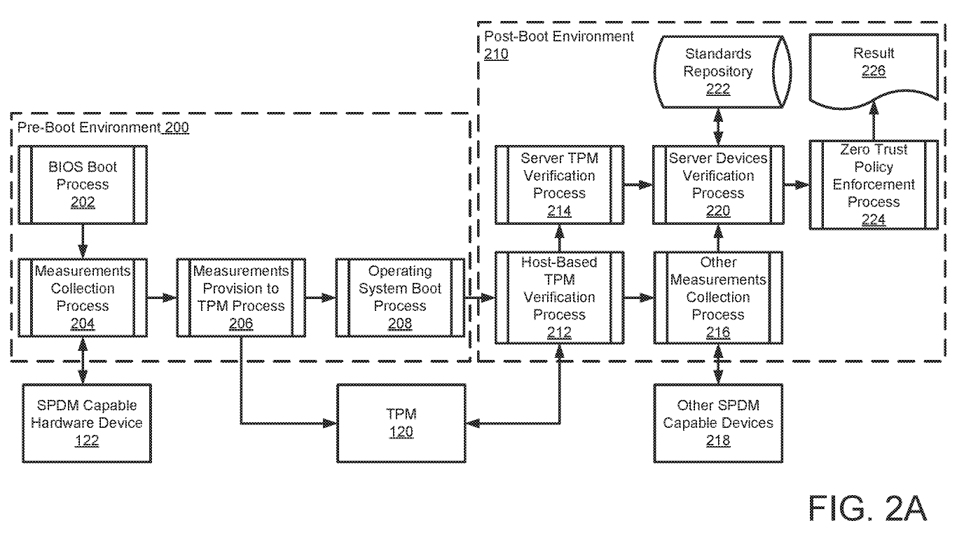

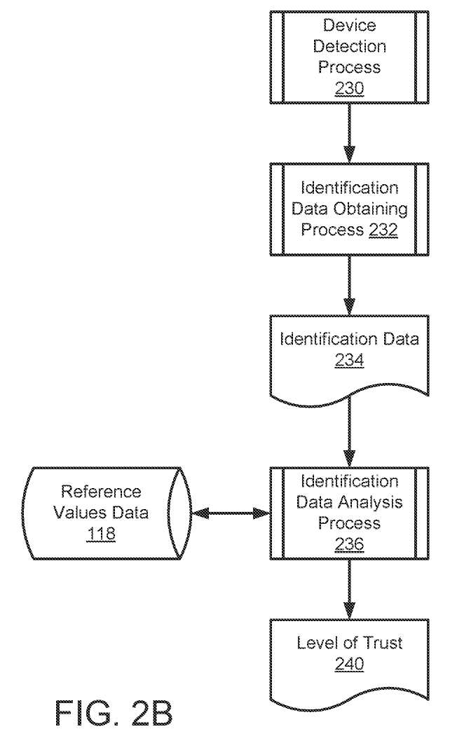

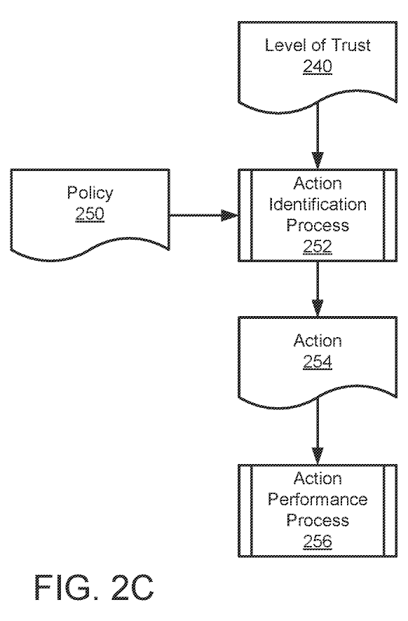

While described with respect to startup manager 102 performing tasks to identify an acceptable manner of managing operation of the hardware components and/or verifying the software components hosted by the hardware components prior to booting to an operation system, it will be appreciated that the operating system may perform these tasks in a post-boot environment. Refer to the description of FIG. 2A for additional details.

TPM 120 may be a hardware component that is distinguishable from the hardware processor that hosts startup manager 102 and may provide security management services for data processing system 100 (e.g., may comply with ISO/IEC 11889:2009, any of the TPM Library specification such as Version 2.0, and/or may conform operation to other industry standards). To provide the security management services, TPM 120 may (e.g., in collaboration with startup manager 102) (i) facilitate verification of startup data 110 using reference values data 118 to establish trust in each portion of startup data 110 before use (e.g., execution), so that exposure to malicious or erroneous software is unlikely (e.g., is not executed), (ii) store and restrict use of secrets (e.g., public/private keys, etc.) based on security posture of data processing system 100, and (iii) facilitate the identification of (e.g., in collaboration with software components of the data processing system such as startup manager 102) the security posture of data processing system 100 based on measurements of various components (e.g., firmware hosted by various devices (e.g., 122, 124), software loaded into data processing system 100, hardware/software component presence/absence, etc.) of data processing system 100. Reference values data 118 may include secure boot data usable to verify the integrity and trust in startup data 110 (e.g., various portions of startup data 110) prior to use of (the various portions of) startup data 110. For example, reference values data 118 may include hashes and/or other types of information usable to cryptographically verify trust and integrity of startup data 110. TPM 120 may include data (e.g., a hash, a signature, etc.) usable to verify integrity of reference values data 118.

Reference values data 118 may also include a store of trusted identification data (e.g., certificates, digest of certificates) for at least a portion of the devices operably connected to the data processing system. The store of trusted identification data may: (i) be populated by startup manager 102 upon establishing trust in a device by performing the certificate verification process, and/or (ii) may be established by a management entity of data processing system 100 (e.g., a manufacturer of the data processing system) and/or another trusted entity. Reference values data 118 may be stored in secured storage 116. Secured storage 116 may include a hardware storage device for storing data. For example, secured storage 116 may be implemented with a solid state storage device operably connected via a serial peripheral interface (SPI) bus to a processor of data processing system 100. Access to secured storage 116 may be restricted to certain entities and/or for certain uses. For example, secured storage 116 may only be accessible by startup manager 102 for performing tasks during and/or related to startup. The contents of secured storage 116 may be generally inaccessible without providing various credentials such as passwords.

Once the device measurements have been provided to TPM 120 (e.g., and presuming data processing system 100 has been determined to be in a predetermined state using, at least in part, TPM 120), startup manager 102 may hand off management of the operation of data processing system 100 to operation manager 104. Operation manager 104 may include, for example, an operating system, drivers, and/or other entities through which applications 106 may provide all, or a portion of, their functionality. Operation manager 104 may be booted to using startup data 110. Thus, if startup data 110 includes malicious code, undesired code, unauthorized code, etc., then operation manager 104 may operate in a manner that diverges from a desired manner. To reduce this possibility, as discussed above, startup manager 102 may perform various actions to improve a likelihood that data processing system 100 operates in a predetermined (e.g., desired) manner.

Applications 106 may include any type and quantity of applications (e.g., software components) that may provide any type and quantity of computer-implemented services. To do so, applications 106 may generate, store, modify, read, and/or otherwise use application data 114 stored in general storage 108.

General storage 108 may be implemented using physical devices that provide data storage services (e.g., storing data and providing copies of previously stored data). The devices that provide data storage services may include hardware devices and/or logical devices. For example, general storage 108 may include any quantity and/or combination of memory devices (e.g., volatile storage), long term storage devices (e.g., persistent storage), other types of hardware devices that may provide short term and/or long term data storage services, and/or logical storage devices (e.g., virtual persistent storage/virtual volatile storage). General storage 108 may be accessible. For example, operation manager 104 may manage and provide access to data stored in general storage 108.

When providing their functionalities, applications 106 may utilize the functionality of operation manager 104 (e.g., to access computing resources such as processor cycles, transitory storage space, etc.). Thus, if operation manager 104 does not operate in the predetermined manner, then applications 106 may also operate in a manner that diverges from a desired and/or expected manner. The divergence of applications 106 and/or operation manager 104 may cause data processing system 100 to not provide (or provide in a compromised manner) all, or a portion, of the computer-implemented services that are to be provided by data processing system 100.

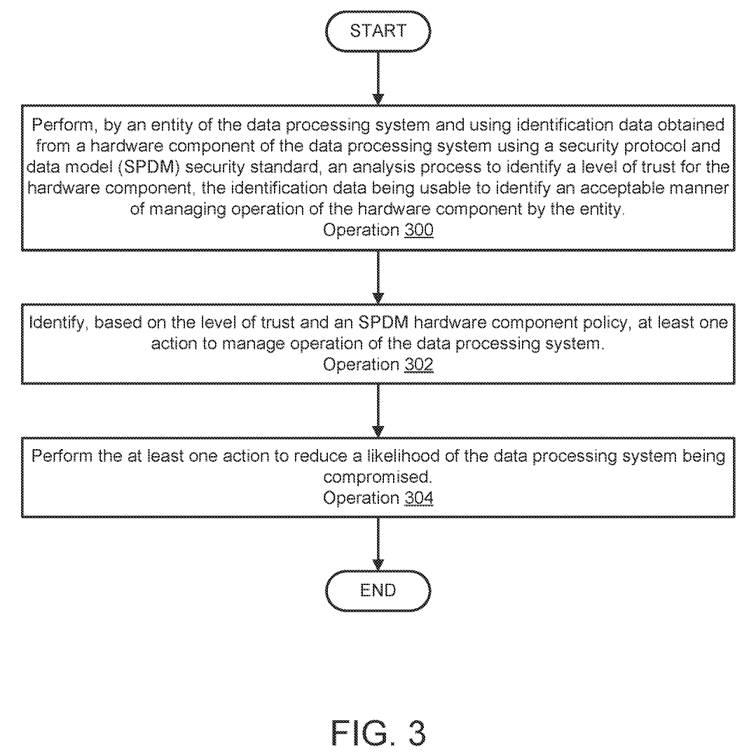

When providing their functionality, any components of data processing system 100 may perform all, or a portion, of the actions and methods illustrated in FIGS. 2A-3.

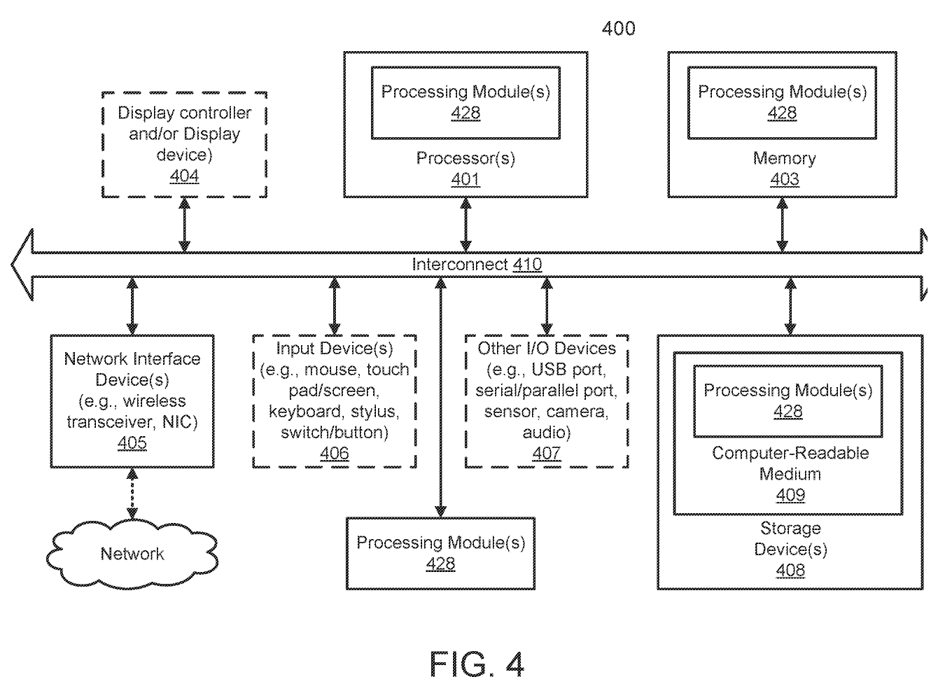

Data processing system 100 (and/or components thereof) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 226, 234, etc.) is used to represent data structures, a second set of shapes (e.g., 202, 204, etc.) is used to represent processes performed using and/or that generate data, a third set of shapes (e.g., 222, 118, etc.) is used to represent large scale data structures such as databases, and a fourth set of shapes (e.g., 122, 120, etc.) is used to represent hardware components (e.g., also referred to as devices).

Turning to FIG. 2A, a first data flow diagram in accordance with an embodiment is shown. The first data flow diagram may illustrate data used in and data processing performed in managing operation of a data processing system (e.g., similar to data processing system 100 shown in FIG. 1) in a manner that improves a likelihood that the data processing system operates as desired.

To manage operation of the data processing system, generally, a startup process may be performed. The startup process may cause the environment of the data processing system to evolve over time from a pre-boot environment (e.g., 200) to a post-boot environment (e.g., 210) where the data processing system may be in condition to provide desired computer-implemented services. Generally, pre-boot environment 200 refers to the state of the data processing system prior to handing off management to a general management entity, and post-boot environment 210 refers to the state of the data processing system after handing off management to the general management entity (e.g., an operating system). During the startup, various processes may be performed, as will be discussed below, to place the data processing system into a desired security posture where it is less susceptible to malicious attacks.

To begin the startup, basic input/output system (BIOS) boot process 202 (or other types of boot processes, such as to unified extensible firmware based entities, it should be appreciated that BIOS boot process 202 refers to any such processes) may be performed. BIOS boot process 202 may be initiated by powering on the data processing system or resetting the system. During BIOS boot process 202, the BIOS program code may be loaded by a processor (e.g., via a serial peripheral interface (SPI) bus and from a protected storage such as secured storage 116). The BIOS may perform tasks related to startup management for the data processing system during pre-boot environment 200 (e.g., similar to startup manager 102 shown in FIG. 1). For example, the BIOS may perform a secure boot procedure to check program code (e.g., firmware) of various hardware and/or software components (e.g., drivers) in a predefined sequence. Pre-boot environment 200 may include operations performed (e.g., by the BIOS) to hand off management of the data processing system to an operation manager (e.g., an operating system) of the data processing system.

Once the BIOS has been booted, measurements collection process 204 may be performed. During measurements collection process 204, security data (e.g., various untrusted data structures, may include identification data and/or measurements, refer to the description of startup data 110 shown in FIG. 1) may be collected from the hardware and/or software components of the data processing system. The security data may be usable to identify an acceptable manner of managing operation of the hardware components by the BIOS and/or verify the authenticity and/or integrity of software hosted by the hardware components using trusted data structures. The identification data obtained as part of the security data may include cryptographically verifiable certificates and/or digest of the certificates. The measurements obtained as part of the security data may include data structures including cryptographic hashes or digital fingerprints that represent the current state of a device's firmware, configuration, drivers, management entity code, and/or other components that may be modified in undesired manners.

For example, the BIOS may perform measurements collection process 204 based on a security protocol and data model (SPDM) security standard. The SPDM security standard may be a data model for hardware components/devices of data processing systems, which may specify, at least: (i) methods of security communication between the hardware components, (ii) minimum standards of data to be made available to other hardware components, (iii) security information to be made available to the other hardware components, and/or (iv) other information. When performing measurements collection process 204, a list of hardware components of the data processing system that are compliant with the SPDM security standard may be obtained. The list of hardware components may be obtained using: (i) an existing list of hardware components that are compliant with the SPDM security standard, and (ii) any new hardware components of the data processing system that are not identified in the existing list.

To collect the security data from the hardware components, the hardware components may be required to be compliant with the SPDM security standard (e.g., SPDM capable hardware device 122). Compliance with the SPDM security standard may allow the security data to be collected in a format, using communication protocols, and/or including information specified by the SPDM security standard (e.g., managed by the Distributed Management Task Force (DMTF)). The security data may be usable to establish an acceptable level of trust that the hardware components will not act maliciously towards the data processing system. For additional details regarding measurements collection process 204, refer to FIGS. 2B-2C.

During measurements collection process 204, the identification data may be used to identify levels of trust for hardware components. Based on the levels of trust and an SPDM hardware component policy, actions may be identified to manage operation of the data processing system. For example, the SPDM hardware component policy may indicate that measurements are to be collected for certain hardware components.

The measurements collected from the certain hardware components during measurements collection process 204 may be used to perform measurements provision to trusted platform module (TPM) process 206. During measurements provision to TPM process 206, the BIOS may provide the measurements to the TPM of the data processing system (e.g., TPM 120). TPM 120 may include (and/or may be included as part of) a secure hardware component (e.g., a chip) with physical security mechanisms that reduce a likelihood of malicious and/or erroneous software compromising the data processing system (e.g., by verifying the authenticity and/or integrity of software hosted by various hardware components). The measurements may be provided to TPM 120 following a set of specifications and/or standards such as the Trusted Computing Group PC Client Platform Firmware Profile (TCP PFP). TPM 120 (e.g., reports generated by TPM 120) may then be used to compute a security posture of the data processing system (e.g., in collaboration with startup manager 102). Based on the security posture determined, at least in part, using TPM 120, booting may be allowed to proceed, some functions of the data processing system may be limited, and/or other remedial actions may be performed should the security posture not meet certain requirements (e.g., activity facilitated by the TPM may be policy driven, with the policies being keyed to the security posture of the data processing system as calculated using the TPM). Refer to the description of FIG. 1 for additional details regarding TPM 120.

Once the measurements have been provided to TPM 120 (e.g., and presuming that the measurements indicate an acceptable security posture), operating system boot process 208 may be performed. During operating system boot process 208, program code for an operating system and/or other type of operational management entity (e.g., operation manager 104 shown in FIG. 1) may be loaded onto the processor and booted so that management of the operation of the data processing system may be handed off from the BIOS to the operating system. After the handoff, the BIOS may shut down, be placed in standby, etc. Management may be handed off to the operating system to place the data processing system into a predetermined manner of operation (e.g., a manner of operation that supports execution of applications). The operating system may, for example, provide abstracted access to resources utilized by the applications, manage data storage and data retrieval, and/or perform other actions that allow for the applications that provide (all or a portion of) the computer-implemented services to execute on the data processing system.

Booting the operating system may indicate a transition from pre-boot environment 200 to post-boot environment 210. Post-boot environment 210 may include operations performed (e.g., by a management entity of the data processing system such as the operating system) to manage operation of the data processing system based on a security posture of the data processing system (e.g., established using TPM 120).

Once the operating system is booted, host-based TPM verification process 212 may be performed (e.g., a host-based verification process may be performed using the TPM of the data processing system). During host-based TPM verification process 212, TPM 120 may perform tasks related to security management of the data processing system. To do so, measurements obtained from the BIOS may be used to perform security verification processes of the hardware and/or software components using TPM 120. For example, reports generated by TPM 120 may be used to verify the authenticity and/or integrity of untrusted data structures (e.g., the measurements) using trusted data structures, such as trusted hashes, and security programs such as a signature verification algorithm. The trusted data structures may be established during manufacturing of the data processing system and may be stored in TPM 120 and/or may be obtained by TPM 120 from trusted data sources (e.g., a unified extensible firmware (UEFI) signature database).

Host-based TPM verification process 212 may establish a security posture of the data processing system. The security posture may be based on a result of the security verification processes performed using TPM 120. For example, if, using reports generated by TPM 120, the authenticity and/or integrity of all and/or a portion of the hardware components is unable to be verified (e.g., the security posture includes indications of compromise), actions may be performed to reduce the likelihood of compromise of the data processing system. The actions may include limiting use of secrets managed by TPM 120 by the data processing system (e.g., the operating system) based on the security posture of the data processing system and/or performing other actions. The actions performed using TPM 120 may result in limited and/or reduced functionality of the operating system.

If at least one hardware component is unable to be verified using TPM 120 (e.g., using reports generated by TPM 120 trust is unable to be established in software hosted by the at least one hardware component), the measurements obtained from the at least one hardware component may be provided to a remote entity (e.g., a server and/or any other management system for the data processing system). The measurements collected from the at least one hardware component may be used to perform server TPM verification process 214. During server TPM verification process 214, the remote entity may perform tasks related to verifying the integrity and/or authenticity of the at least one hardware component. To do so, the remote entity may use a data structure including expected integrity measurements of the at least one hardware component’s software (e.g., a component refence integrity manifest). The remote entity may provide a response to the operating system indicating whether the at least one hardware component is verified.

To reduce the amount of time to complete booting of the data processing system, some devices (e.g., not necessary to boot the data processing system) may not be initialized until after operation of the data processing system is handed off to the operating system. To verify those devices, other measurements collection process 216 may be performed. During other measurements collection process 216, security data (e.g., identification data, measurements) usable to verify the authenticity and/or integrity of software hosted by the devices (e.g., other SPDM capable devices 218) may be obtained (e.g., by the operating system). The security data may be obtained based on an SPDM security standard and other SPDM capable devices 218 may be compliant with the SPDM security standard. The identification data may be used to identify levels of trust in the hardware components and actions may be identified based on the SPDM hardware component policy to manage operation of the data processing system by the operating system in a manner similar to that described with respect to measurements collection process 204.

To verify the measurements obtained from other SPDM capable devices 218 (e.g., for hardware components for which the SPDM hardware component policy indicates measurements are to be collected), server devices verification process 220 may be performed. During server devices verification process 220, the measurements may be provided to a remote system (e.g., a server and/or other backend system) and used to perform the device verification processes remotely. To perform the device verification processes, the remote system may use trusted data structures stored in standards repository 222 to verify the untrusted data structures (e.g., the measurements). Standards repository 222 may include a database of trusted integrity measurements (e.g., a TCG component reference integrity manifest) which may be used to establish trust in the measurements from each device of other SPDM capable devices 218.

An outcome of any of the device verification processes performed by components of the data processing system and/or remote entities may be used to perform zero trust policy enforcement process 224. The outcome may include an indication of whether any of the hardware components are unable to be verified (e.g., whether trust in any of the hardware components is unable to be established). During zero trust policy enforcement process 224, remedial measures may be performed (e.g., by the operating system) if the outcome indicates a hardware component is unable to be verified. The remedial measures may be based on a predetermined zero trust policy that may reduce a likelihood of compromise and/or other undesired impacts on the data processing system. For example, the zero trust policy may include: (i) preventing the hardware component that is unable to be verified from booting, (ii) shutting down the data processing system, (iii) providing a notification to a user of the data processing system indicating the hardware component is unable to be verified, (iv) obtaining user input regarding any actions that are to be performed as a result of the hardware component being unable to be verified, and/or (v) other remedial measures.

As a result of performing zero trust policy enforcement process 224, result 226 may be obtained. Result 226 may include instructions for the operating system and/or any other management entity of the data processing system to perform various remedial measures based on the zero trust policy. Based on result 226, the operating system may manage operation of the data processing system.

Thus, by implementing the data flow shown in FIG. 2A, a system in accordance with embodiments disclosed herein may be used to manage operation of a data processing system in a manner that reduces a likelihood of the data processing system becoming compromised and/or operating in an undesired manner. Consequently, computer-implemented services provided using the data processing system may be provided as desired.

Turning to FIG. 2B, a second data flow diagram in accordance with an embodiment is shown. The second data flow diagram may illustrate data used in and data processing performed in identifying a level of trust for a device of a data processing system during a startup of the data processing system (which may include processes performed by a startup manager of the data processing system while the system is in a pre-boot environment and/or by an operation manager while the system is in a post-boot environment). FIG. 2B may include an expansion of measurements collection process 204 and/or other measurements collection process 216 shown in FIG. 2A.

To identify the level of trust for the device, device detection process 230 may be performed by an entity of the data processing system (e.g., a startup manager such as the BIOS and/or an operation manager such as the operating system). Device detection process 230 may be performed following basic input/output system (BIOS) boot process 202 and/or during other measurements collection process 216 described in FIG. 2A.

Once booted, the entity may perform enumeration tasks to manage startup of the data processing system, such as device detection process 230. During device detection process 230, the entity may identify devices (e.g., also referred to as hardware components) operably connected to the data processing system and obtain identifiers for the devices, such as globally unique identifiers (GUIDs) and/or other unique codes and/or numbers usable to identify the devices. The identifiers for any detected devices may be used to perform identification data obtaining process 232.

During identification data obtaining process 232, identification data 234 for a device detected during device detection process 230 may be obtained by the entity. Identification data 234 may be obtained using a security protocol and data model (SPDM) security standard and via an SPDM message exchange with the device, and may include: (i) a cryptographically verifiable certificate for the device, (ii) a digest of the certificate for the device, and/or other identification data.

Identification data 234 may be usable to identify an acceptable manner of managing operation of the device by the entity. For example, the certificate and/or digest for the device may be usable to establish trust in the device by the data processing system (e.g., by verifying the identity of the device). Based on the degree to which the data processing system is able to establish trust, the data processing system may identify and perform actions to dictate a manner and/or extent to which the device is allowed to interact with the data processing system. Refer to the description of FIG. 2C for additional details regarding identifying and performing the actions.

For example, the certificate may include information such as: (i) device information, such as the device serial number, an identifier for the device, and/or other device information, (ii) information regarding the certificate issuer, such as an identifier for the certificate authority that issued the certificate, a cryptographically verifiable signature of the certificate authority, and/or other certificate issuer information, (iii) a validity period for the certificate, and/or (iv) other information. The certificate may also include a certificate chain (e.g., a sequence of certificates) usable to establish trust in the device by verifying the certificate is signed by a root certificate authority trusted by the data processing system.

Performing identification data obtaining process 232 may also include obtaining a digest based on the certificate for the device. For example, the digest may be obtained by: (i) obtaining, by the entity and via an SPDM message exchange with the device, the certificate for the device, and (ii) applying, by the entity, a predetermined function (e.g., a hash function and/or other algorithm, the predetermined function may also include a plurality of functions) to the certificate to obtain the digest. Obtaining the digest may also include: (i) providing, by the entity, a request for the digest to the device, and (ii) receiving the digest from the device in response to the request.

For example, a startup manager of the data processing system (e.g., the entity) may detect a graphics processing unit (GPU) operably connected to the data processing system during device detection process 230. In a first example, the startup manager may obtain the digest by obtaining, using the SPDM security standard, a certificate for the GPU. A digest for the certificate may be obtained by applying a predetermined hash function (e.g., SHA-256, SHA-512, SHAKE) to the certificate. In a second example, the startup manager may obtain the digest by requesting the digest from the GPU, and receiving the digest in response (e.g., the digest may be stored in the GPU and/or computed by the GPU).

Upon obtaining identification data 234, identification data analysis process 236 may be performed. During identification data analysis process 236, an analysis process may be performed by the entity to identify level of trust 240 for the device. Performing identification data analysis process 236 may include using a store of trusted identification data included as part of reference values data 118 described in FIG. 1. The store of trusted identification data may include: (i) known good identification data (e.g., certificates and/or digests for devices indicating a trusted level of trust in the devices), (ii) known bad identification data (e.g., certificates and/or digests for devices indicating an untrusted level of trust in the devices), and/or (iii) other information regarding device certificates and/or digests. For example, known good identification data may include identification data based on certificates and/or digests for devices produced by a manufacturer of the data processing system. Known bad identification data, for example, may include certificates and/or digests for potentially malicious devices, devices with identified security issues, and/or otherwise unsupported devices.

For example, a predetermined hash function may be applied to a device certificate to obtain a certificate hash value (e.g., a digest for the device). Performing identification data analysis process 236 may include comparing the certificate hash value to hash values included in the store of trusted identification data (e.g., by performing a matching process).

An outcome of performing identification data analysis process 236 may include level of trust 240. Level of trust 240 may include: (i) a trusted level of trust, (ii) an untrusted level of trust, and/or (iii) an indeterminate level of trust. A trusted level of trust may be obtained if the identification data (e.g., device certificate and/or digest) matches known good identification data included in the store of trusted identification data (e.g., a known good device certificate and/or digest). For example, a digest included as part of the identification data may match a known good digest when a difference between the certificate hash value and a known good hash value (e.g., a known good digest) is zero (e.g., the hash values match).

Similarly, an untrusted level of trust may be obtained if the identification data matches known bad identification data (e.g., a difference between the certificate hash value and a known bad hash value is zero).

An indeterminate level of trust may be obtained if the identification data does not match identification data included in the store of trusted identification data. For example, an indeterminate level of trust may be obtained for the device if the digest does not match a digest included in the store of trusted identification data (e.g., a difference between the certificate hash value and hash values included in the store of trusted identification data is nonzero).

Thus, by implementing the data flow shown in FIG. 2B, a system in accordance with embodiments disclosed herein may be used to identify a level of trust for a device using a store of trusted identification data. By comparing identification data for the device to identification data in the store of trusted identification data, the level of trust for the device may be obtained in a manner that improves startup speed while maintaining a desired level of security, which may reduce a resource consumption during startup.

Turning to FIG. 2C, a third data flow diagram in accordance with an embodiment is shown. The third data flow diagram may illustrate data used in and data processing performed in identifying and performing at least one action to reduce a likelihood of a data processing system being compromised based on a level of trust for a device and an SPDM hardware component policy. FIG. 2C may include an expansion of measurements collection process 204 and/or other measurements collection process 216 shown in FIG. 2A.

Based on level of trust 240, action identification process 252 may be performed. During action identification process 252, level of trust 240 and policy 250 may be used to identify at least one action (e.g., action 254) to manage operation of the data processing system. Refer to the description of FIG. 2B for additional details regarding level of trust 240.

Policy 250 may include an SPDM hardware component policy, schema, and/or other type of rule set. Policy 250 may include actions keyed to: (i) levels of trust for devices (e.g., hardware components), (ii) types of SPDM devices, and/or (iii) other characteristics of the devices. For example, policy 250 may be obtained from a management entity of the data processing system, such as a manufacturer of the data processing system, a user of the data processing system, a subject matter expert (SME), and/or any other entity that participates in managing operation of the data processing system.

Policy 250 may be obtained from the management entity asynchronously with respect to performing the startup. For example, policy 250 may be provided to the data processing system by the management entity during a period in which the data processing system is booted and able to communicate with a server managed by the management entity (e.g., via a network and/or other type of connection). In a second example, policy 250 may be customized based on preferences of a user of the data processing system. In a third example, policy 250 may be provided to the data processing system via an update to software components of the data processing system (e.g., from a manufacturer of the data processing system).

The types of SPDM devices may include: (i) specific devices (e.g., based on identifiers obtained for the devices such as serial numbers and/or GUIDs), (ii) categories and/or classes of devices (e.g., processors, storage devices), (iii) specific types of devices (e.g., central processing units (CPUs), graphics processing units (GPUs), data processing units (DPUs)), (iv) interactions with other hardware and/or software components of the data processing system requested by the device (e.g., storing data in storage of the data processing system, communicating with programs hosted by the data processing system, communicating with other devices), and/or other types of SPDM devices.

Obtaining action 254 during action identification process 252 may include performing a search using policy 250 and level of trust 240 and/or the type of device as a key for the search. Action 254 may include one or multiple actions, which may include: (i) preventing the device from performing at least a portion of its functionality (e.g., restricting the device from performing functions and/or limiting interactions with the data processing system), (ii) allowing the device to perform at least a portion of its functionality (e.g., enabling the device to perform at least a portion of its functions and/or interact with the data processing system as requested by the device), (iii) performing, by the entity, a measurement process using the SPDM security standard for the device (e.g., to verify the integrity and/or authenticity of software hosted by the device prior to booting the device), (iv) logging information regarding the device (e.g., in a log maintained by the BIOS, operating system, and/or any other entity), (v) quarantining the device (e.g., until the device can be verified via other methods such as a certificate analysis process), (vi) screening activity of the device for indications of malicious behavior, and/or (vii) other actions.

The type of SPDM device may impact action 254 that is to be performed by the entity based on policy 250. For example, different types of devices may have different levels of risk of compromising the data processing system. For types of devices with high levels of risk, actions that result in more restrictions on device activity may be performed relative to actions performed to manage devices with low levels of risk (e.g., based on any scale for assigning levels of risk). For example, communication capabilities of DPUs may be restricted due to the types of communications used by DPUs while performing their functionality (e.g., communications may occur between the DPU and the data processing system) resulting in a high level of risk of compromising the data processing system. However, communication capabilities of GPUs may be relatively less restricted due to the types of communications used by the GPUs (e.g., communications may occur between multiple GPUs operably connected to the data processing system) resulting in a low level of risk of compromising the data processing system.

Consider a scenario in which an SPDM compliant network interface card (NIC) is detected by the BIOS during a startup of the data processing system. If the NIC has a trusted level of trust (e.g., the NIC is a known good device), policy 250 may indicate that a measurement process is to be performed for the NIC. If, as a result of the measurement process, the authenticity and/or integrity of the software hosted by the NIC is verified, the NIC may be allowed to perform its functionality (e.g., the NIC may be allowed to connect the data processing system to a network). If the NIC has a level of trust that is untrusted (e.g., the NIC is a known bad device), policy 250 may indicate that the NIC is not allowed to perform its functionality. For example, the NIC may be prevented from communicating with the data processing system to reduce a risk of compromise of the data processing system. If the NIC has a level of trust that is indeterminate, policy 250 may indicate that for indeterminate NICs, information regarding the NIC is to be logged by the BIOS, and activity of the NIC is to be screened for malicious behavior. The NIC may be allowed to perform a portion of its functionality due to the type of device (e.g., NIC) being determined to have a low risk of compromising the data processing system.

Consider a second scenario in which an SPDM compliant non-volatile memory express (NVME) drive is detected by the BIOS during a startup of the data processing system. If the NVME drive has a level of trust that is indeterminate, policy 250 may indicate that the NVME drive is to be quarantined (e.g., the NVME drive is to be isolated from the data processing system) until a trusted level of trust in the NVME drive is established (e.g., using a server managed by a management entity of the data processing system). The action identified based on policy 250 may include quarantining the NVME drive due to the type of device (e.g., NVME drive) having a high level of risk of compromising the data processing system.

Action 254 may then be performed during action performance process 256 to reduce a likelihood of the data processing system being compromised.

Action 254 may indicate that a certificate analysis process is to be performed for the device (e.g., by the entity and using a certificate for the device obtained as part of the identification data, refer to FIG. 2A). For example, action 254 may indicate that the certificate analysis process is to be performed for devices for which the level of trust is indeterminate. The certificate analysis process may be used to establish a trusted level of trust for the device.

Performing the certificate analysis process may include (i) performing a signature verification process to establish trust in each portion of the certificate (e.g., each certificate of a certificate chain), and (ii) verifying that a root certificate authority for the certificate is trusted by the entity. The signature verification process may include using, by the entity, a public key of a public private key pair to verify the authenticity of the private key used by the certificate issuer (e.g., the certificate authority) to sign at least a portion of the certificate (e.g., a certificate in the certificate chain). A chain of trust may be established by verifying the certificate authority’s certificate. Verifying the certificate authority’s certificate may include identifying that the certificate authority’s certificate was issued by a trusted root certificate authority. The entity may verify, during the certificate analysis process, that the root certificate authority is trusted by comparing an identifier for the root certificate authority to a list of trusted root certificate authorities stored as part of reference values data 118 (not shown).

A result of the certificate analysis process (not shown) may include: (i) an indication that the device certificate is trusted (e.g., a trusted level of trust for the device was able to be established during the certificate analysis process), (ii) an indication that the device certificate is untrusted (e.g., an untrusted level of trust for the device was able to be established during the certificate analysis), and/or (iii) other information.

Based on the result of the certificate analysis process, a reference values data updating process may be performed. During the reference values data updating process, the store of trusted identification data (e.g., part of reference values data 118, not shown) may be updated for use during future startups of the data processing system. For example, if the result indicates that the device certificate is trusted, the device certificate and/or a digest based on the device certificate may be stored in the store of trusted identification data as known good identification data. In another example, if the result indicates that the device certificate is untrusted, the device certificate and/or a digest based on the device certificate may be stored in the store of trusted identification data as known bad identification data. The digest of the device certificate may be obtained using methods described with respect to identification data obtaining process 232 shown in FIG. 2B.

Action 254 may indicate that a measurement process is to be performed for the device to verify the authenticity and/or integrity of software hosted by the device. The measurement process may be performed by the entity using the SPDM security standard. Performing the measurement process may include performing an SPDM message exchange with the device to obtain at least one measurement from the device. The at least one measurement may include security data (e.g., hashes of software code hosted by the hardware components) usable to validate authenticity and/or integrity of software hosted by the device. Refer to the description of FIG. 2A for additional details regarding obtaining device measurements using the SPDM security standard.

The at least one measurement obtained from the device may be used to perform a measurement verification process. During the measurement verification process, a security posture of the data processing system may be evaluated using a trusted platform module (TPM) of the data processing system (e.g., similar to TPM 120 shown in FIGS. 1 and 2A). Evaluating the security posture of the data processing system may include checking the integrity and/or authenticity of the software hosted by the device. To do so, the at least one measurement and data structures trusted by the TPM may be used.

For example, the at least one measurement may include hashes of software code hosted by the device, which may be usable to verify the authenticity and/or integrity of the device by comparing the hashes to trusted (e.g., known good) hashes. The trusted data structures may be stored in the TPM and/or may be provided to (e.g., loaded into) the TPM from trusted data sources (e.g., reference values data 118). Refer to the description of FIGS. 1 and 2A for additional details regarding the TPM.

A result of performing the measurement verification process may be obtained, which may indicate: (i) the at least one measurement is verified (e.g., trusted), or (ii) the at least one measurement is not verified (e.g., untrusted and/or indeterminate). If the result indicates that the at least one measurement is verified, the authenticity and/or integrity of the device may also be verified (e.g., the security posture may indicate that the device is trusted). Booting of the device may then be allowed to proceed to enable at least a portion of functionality of the device.

If the result indicates that the at least one measurement is not verified, the authenticity and/or integrity of the device may also not be verified (e.g., the security posture may indicate that the device is untrusted and/or indeterminate). Based on the security posture, the TPM may limit use of secrets by the data processing system (e.g., until trust in the device is able to be established). For example, if the security posture of the data processing system indicates that the device may be compromised, the TPM may limit use of secrets (e.g., public/private keys, etc.) by the data processing system. In doing so, the secrets managed by the TPM may have a reduced risk of being accessed by unauthorized entities and/or a risk of other undesired impacts may be reduced.

If the result indicates that the at least one measurement for the device is not verified, reference values data 118 may be updated. Updating reference values data 118 may include removing trusted identification data for the device from the store of trusted identification data. In doing so, the device may not be recognized as having a trusted level of trust during subsequent startups of the data processing system.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2C may perform various methods to manage data used to provide computer-implemented services. FIG. 3 illustrates a method that may be performed by the components of the system of FIGS. 1-2C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of a data processing system in accordance with an embodiment is shown. The method may be performed, for example, by any of the components of the system of FIG. 1, and/or any other entity without departing from embodiments disclosed herein. The method may be performed during a startup of the data processing system.

At operation 300, an analysis process may be performed by an entity of the data processing system and using identification data obtained from a hardware component of the data processing system using an SPDM security standard to identify a level of trust for the hardware component. The identification data may be usable to identify an acceptable manner of managing operation of the hardware component by the entity. Performing the analysis process may include: (i) obtaining, by the entity and via an SPDM message exchange with the hardware component, the identification data, (ii) identifying, by the entity and using at least the identification data and a store of trusted identification data, the level of trust for the hardware component, (iii) providing the identification data to another entity (e.g., a remote entity) responsible for performing the analysis process and receiving the level of trust in response, and/or (iv) other methods.

Obtaining the identification data may include: (i) detecting (e.g., by the entity, which may include a startup manager of the data processing system such as the BIOS) operable connection of the hardware component to the data processing system, (ii) requesting, via a message, the identification data from the hardware component, (iii) receiving, via a message, the identification data in response, (iv) receiving the identification data from another entity (e.g., an intermediate entity), (v) reading the identification data from storage, and/or (vi) other methods.

The identification data may include a cryptographically verifiable certificate and/or a digest of the certificate. Obtaining the digest may include: (i) obtaining, by the entity and via an SPDM message exchange with the hardware component, the certificate for the hardware component (e.g., as part of the identification data), (ii) applying, by the entity, a predetermined function to the certificate to obtain the digest, (iii) receiving the digest from another entity, (iv) reading the digest from storage, and/or (v) other methods.

Applying the predetermined function to the certificate to obtain the digest may include: (i) using the certificate as input to an algorithm, such as a hash function and/or any other type and/or quantity of functions, (ii) obtaining, as output from the algorithm, the digest, (iii) providing, by the entity, the certificate and/or instructions for applying the predetermined function to the certificate to another entity and receiving the digest in response, and/or (iv) other methods.

Obtaining the digest may also include: (i) providing, by the entity, a request for the digest to the hardware component (e.g., via a message to the entity using any communication protocol, by storing the request in storage followed by subsequent retrieval of the request by the hardware component, by providing the request to another entity that is to provide the request to the hardware component), (ii) receiving the digest from the hardware component in response to the request (e.g., receiving the digest via a message from the hardware component, reading the digest from a storage used by the hardware component, obtaining the digest from another entity which obtained the digest from the hardware component), and/or (iii) other methods.

Identifying the level of trust for the hardware component may include: (i) comparing the identification data to identification data included in the store of trusted identification data, (ii) obtaining a result of the comparing, the result indicating whether the identification data matches (and/or otherwise agrees with) identification data included in the store of trusted identification data (e.g., reading the result, receiving the result from another entity), (iii) assigning, based on the result, the level of trust to the hardware component, and/or (iv) other methods.

Comparing the identification data to identification data included in the store of trusted identification data may include: (i) performing a matching process to determine whether the identification data matches any identification data included in the store of trusted identification data, (ii) performing any other comparison process to determine whether the identification data agrees with identification data included in the store of trusted identification data, (iii) providing the identification data to another entity (e.g., an entity with access to and/or that is responsible for managing the store of trusted identification data) responsible for comparing the identification data to identification data included in the store of trusted identification data, and/or (iv) other methods.

Assigning the level of trust to the hardware component may include: (i) determining which classification of identification data the identification data matches (and/or otherwise agrees with), the classification including known good identification data and/or known bad identification data, (ii) determining the level of trust based on the classification, and/or (iii) other methods. In a first example, if the identification data matches known good identification data, the level of trust may be trusted. In a second example, if the identification data matches known bad identification data, the level of trust may be untrusted. If the identification data does not match known good identification data and/or known bad identification data, an indeterminate level of trust may be assigned to the hardware component.

At operation 302, at least one action may be identified to manage operation of the data processing system based on the level of trust and an SPDM hardware component policy. The SPDM hardware component policy may be keyed to levels of trust for hardware components and/or types of SPDM hardware components. Identifying the at least one action may include: (i) obtaining the policy (e.g., reading the policy from storage, receiving the policy from another entity, generating the policy), (ii) performing a search using the policy and the level of trust for the hardware component and/or the type of hardware component as a key for the search to identify the at least one action, (iii) providing the level of trust for the hardware component and/or the type of hardware component to another entity responsible for identifying the at least one action using the policy and receiving the at least one action in response, and/or (iv) other methods.

At operation 304, the at least one action may be performed to reduce a likelihood of the data processing system being compromised. Performing the at least one action may include: (i) preventing the hardware component from performing at least a portion of its functionality (e.g., preventing the hardware component from booting, restricting access by the hardware component to data stored on the data processing system, restricting an ability of the hardware component to communicate with the data processing system), (ii) allowing the hardware component to perform at least a portion of its functionality (e.g., permitting the hardware component to boot, allowing the hardware component to access data stored on the data processing system, allowing the hardware component to communicate with the data processing system), (iii) performing, by the entity, a measurement process using the SPDM security standard for the hardware component, (iv) logging information regarding the hardware component (e.g., generating an entry in a log including the level of trust for the hardware component and/or other information regarding the hardware component, providing the level of trust and/or other information regarding the hardware component to another entity responsible for logging the information), (v) quarantining the hardware component (e.g., isolating the hardware component until a trusted level of trust for the hardware component is established), (vi) screening activity of the hardware component for malicious behavior, (vii) performing a certificate analysis process for the hardware component to establish a trusted level of trust for the hardware component, and/or (viii) other methods.

Performing the measurement process may include: (i) obtaining, by the entity, at least one measurement from the hardware component, (ii) analyzing the at least one measurement to determine whether the at least one measurement is a trusted measurement, and/or (iii) other methods.

Obtaining the at least one measurement may include: (i) performing an SPDM message exchange (e.g., initiated by the entity) with the hardware component to obtain the at least one measurement, (ii) requesting the at least one measurement from another entity (e.g., an intermediate entity) and receiving the at least one measurement in response, (iii) reading the at least one measurement from storage, and/or (iv) other methods.

Analyzing the at least one measurement to determine whether the at least one measurement is a trusted measurement may include: (i) obtaining trusted data structures (e.g., stored in a TPM of the data processing system, from data sources trusted by the TPM such as a UEFI signature database), (ii) comparing the at least one measurement to the trusted data structures to obtain a result indicating whether the at least one measurement is the trusted measurement, (iii) providing the at least one measurement to another entity (e.g., a remote entity such as a server) and receiving a response indicating whether the at least one measurement is the trusted measurement, and/or (iv) other methods.

For example, the at least one measurement may include a hash value of a portion of software hosted by the hardware component generated using a predetermined hash function. Analyzing the at least one measurement may include comparing the hash value to a known good hash value trusted by the TPM (e.g., a trusted data structure) in order to obtain a difference. The difference may be zero (e.g., when the hash values match) or nonzero (e.g., when the hash values do not match). If the difference is zero, for example, then the result may indicate that the at least one measurement is the trusted measurement. Otherwise, if the difference is nonzero, then the result may indicate that the at least one measurement is not the trusted measurement.

Performing the certificate analysis process may include: (i) performing a signature verification process to establish trust in each portion of a certificate obtained from the device as part of the identification data, (ii) verifying that a root certificate authority for the certificate is trusted by the entity, (iii) providing the certificate to another entity responsible for performing the certificate analysis process, and/or (iv) other methods.

Performing the signature verification process may include: (i) using, by the entity, a public key of a public private key pair to verify the authenticity of a private key used by a certificate issuer (e.g., a certificate authority) to sign at least a portion of the certificate (e.g., a certificate in a certificate chain), (ii) repeating the signature verification process for each portion of the certificate to establish a chain of trust of the certificate, (iii) providing the certificate to another entity responsible for performing the signature verification process, and/or (iv) other methods.

Verifying that the root certificate authority for the certificate is trusted by the entity may include: (i) identifying the root certificate authority for the certificate, (ii) obtaining an identifier for the root certificate authority, (iii) comparing the identifier to a list, table, and/or other data structure including identifiers for root certificate authorities trusted by the entity, (iv) concluding, based on a result of the comparing, whether the root certificate authority for the certificate is trusted by the entity, and/or (v) other methods. For example, if the identifier for the root certificate authority for the certificate matches an identifier included in a list of root certificate authorities trusted by the entity, it may be concluded that the root certificate authority is trusted by the entity.

The method may end following operation 304.

Thus, as illustrated above, embodiments disclosed herein may provide systems and methods to facilitate startups of a data processing system in a manner that improves startup speed. By using identification data to identify levels of trust for hardware components during the startups, a policy keyed to the levels of trust may be implemented to manage operation of the data processing system. In doing so, the security of the data processing system may be maintained while reducing resource consumption during the startup.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
during a startup of the data processing system:
performing, by an entity of the data processing system and using identification data obtained from a hardware component of the data processing system using a security protocol and data model (SPDM) security standard, an analysis process to identify a level of trust for the hardware component, the identification data being usable to identify an acceptable manner of managing operation of the hardware component by the entity;
identifying, based on the level of trust and an SPDM hardware component policy, at least one action to manage operation of the data processing system; and
performing the at least one action to reduce a likelihood of the data processing system being compromised.

2. The method of claim 1, wherein performing the analysis process comprises:
obtaining, by the entity and via an SPDM message exchange with the hardware component, the identification data; and
identifying, by the entity and using at least the identification data and a store of trusted identification data, the level of trust for the hardware component.

3. The method of claim 2, wherein the identification data comprises a certificate for the hardware component, the certificate being cryptographically verifiable, and/or a digest of the certificate.

4. The method of claim 3, wherein the digest is obtained by applying a predetermined function to the certificate.

5. The method of claim 1, wherein the level of trust comprises at least one level of trust selected from a list consisting of:
trusted;
untrusted; and
indeterminate.

6. The method of claim 1, wherein the SPDM hardware component policy comprises actions keyed to levels of trust for hardware components, and the SPDM hardware component policy is obtained from a management entity of the data processing system.

7. The method of claim 6, wherein the SPDM hardware component policy comprises the actions keyed to types of SPDM hardware components.

8. The method of claim 1, wherein the at least one action to manage operation of the data processing system comprises at least one action selected from a list of actions consisting of:
preventing the hardware component from performing at least a portion of its functionality;
allowing the hardware component to perform at least a portion of its functionality;
performing, by the entity, a measurement process using the SPDM security standard for the hardware component;
logging information regarding the hardware component; and
quarantining the hardware component.

9. The method of claim 1, wherein the SPDM security standard is a data model for hardware components of data processing systems, the SPDM security standard specifying, at least, methods of security communication between the hardware components, minimum standards of data to be made available to other hardware components, and security information to be made available to the other hardware components.

10. The method of claim 1, wherein the entity of the data processing system is a basic input-output system (BIOS).

11. A non-transitory machine-readable medium having instructions stored therein, which when executed by a processor, cause the processor to perform operations for managing operation of a data processing system, the operations comprising:
during a startup of the data processing system:
performing, by an entity of the data processing system and using identification data obtained from a hardware component of the data processing system using a security protocol and data model (SPDM) security standard, an analysis process to identify a level of trust for the hardware component, the identification data being usable to identify an acceptable manner of managing operation of the hardware component by the entity;
identifying, based on the level of trust and an SPDM hardware component policy, at least one action to manage operation of the data processing system; and
performing the at least one action to reduce a likelihood of the data processing system being compromised.

12. The non-transitory machine-readable medium of claim 11, wherein performing the analysis process comprises:
obtaining, by the entity and via an SPDM message exchange with the hardware component, the identification data; and
identifying, by the entity and using at least the identification data and a store of trusted identification data, the level of trust for the hardware component.

13. The non-transitory machine-readable medium of claim 12, wherein the identification data comprises a certificate for the hardware component, the certificate being cryptographically verifiable, and/or a digest of the certificate.

14. The non-transitory machine-readable medium of claim 13, wherein the digest is obtained by applying a predetermined function to the certificate.

15. The non-transitory machine-readable medium of claim 11, wherein the level of trust comprises at least one level of trust selected from a list consisting of:
trusted;
untrusted; and
indeterminate.

16. A data processing system, comprising:
a processor; and
a memory coupled to the processor to store instructions, which when executed by the processor, cause the processor to perform operations for managing operation of a data processing system, the operations comprising:
during a startup of the data processing system:
performing, by an entity of the data processing system and using identification data obtained from a hardware component of the data processing system using a security protocol and data model (SPDM) security standard, an analysis process to identify a level of trust for the hardware component, the identification data being usable to identify an acceptable manner of managing operation of the hardware component by the entity;
identifying, based on the level of trust and an SPDM hardware component policy, at least one action to manage operation of the data processing system; and
performing the at least one action to reduce a likelihood of the data processing system being compromised.

17. The data processing system of claim 16, wherein performing the analysis process comprises:
obtaining, by the entity and via an SPDM message exchange with the hardware component, the identification data; and
identifying, by the entity and using at least the identification data and a store of trusted identification data, the level of trust for the hardware component.

18. The data processing system of claim 17, wherein the identification data comprises a certificate for the hardware component, the certificate being cryptographically verifiable, and/or a digest of the certificate.

19. The data processing system of claim 18, wherein the digest is obtained by applying a predetermined function to the certificate.

20. The data processing system of claim 16, wherein the level of trust comprises at least one level of trust selected from a list consisting of:
trusted;
untrusted; and
indeterminate.
